(19) United States
(12) Patent Application Publication
(10) Pub. No.: US 2013/0153684 A1
(43) Pub. Date: Jun. 20, 2013

(54) Spray gun for expelling a fluid

(71) Applicants: Claude Taranta, Stutensee (DE); Peter Welter, Mannheim (DE); Gunter Niesar, Neuhofen (DE); Marc Nolte, Mannheim (DE); Antonio Zarco Montero, Utrera (ES); Jose Antonio Torres Morato, Moron de la Frontera (ES); Steffen Henkes, Boehl-Iggelheim (DE); Robert Huber, Limburgerhof (DE)

(72) Inventors: Claude Taranta, Stutensee (DE); Peter Welter, Mannheim (DE); Gunter Niesar, Neuhofen (DE); Marc Nolte, Mannheim (DE); Antonio Zarco Montero, Utrera (ES); Jose Antonio Torres Morato, Moron de la Frontera (ES); Steffen Henkes, Boehl-Iggelheim (DE); Robert Huber, Limburgerhof (DE)

(73) Assignee: BASF SE, Ludwigshafen (DE)

(21) Appl. No.: 13/818,244

(22) PCT Filed: Aug. 25, 2011
(86) PCT No.: PCT/EP11/64597

§ 371 Date: Feb. 21, 2013

(30) Foreign Application Priority Data
Aug. 25, 2010 (EP) 10174041.3

(51) Int. Cl. F23D 14/28

(52) U.S. Cl. CPC B05B 12/002; B05B 11/3001; B05B 11/3066; B05B 12/02
USPC 239/337

(57) ABSTRACT

The present invention relates to a spray gun for the expulsion of a fluid, with at least one cylinder (1) in which a piston (2) is mounted movably, the cylinder (1) having formed in it a fluid chamber (3), the volume of which can be varied by means of a movement of the piston (2) and in which at least one first cylinder orifice (5) is formed, and a spray orifice which is connected to the first cylinder orifice (5) of the cylinder (1) via a connecting line (20), so that a fluid, which is received by the fluid chamber (3) and is pressed out through the first cylinder orifice (5) by the pressure exerted by the piston (2), arrives via the connecting line (20) at the spray orifice and is expelled there. The spray gun according to the invention is distinguished by the fact that a fluid valve (21) is arranged in the connecting line (20), and, in the cylinder (1) a sensor (29) is provided, by means of which a defined position of the piston (2), in which fluid is still located in the fluid chamber (3) during the expulsion operation, can be detected, and by means of which the fluid valve (21) can be actuated, the fluid valve (21) being closed by means of the sensor (29) when the defined position of the piston (2) has been detected. The invention relates, furthermore, to the use of such a spray gun for the expulsion of plant protectants.

The present invention relates to a spray gun for the expulsion of a fluid. The spray gun comprises at least one cylinder in which a piston is mounted movably. In the cylinder, a fluid chamber is formed, the volume of which can be varied by means of a movement of the piston and in which at least one first cylinder orifice is formed. The spray gun comprises, furthermore, a spray orifice which is connected to the first cylinder orifice of the cylinder via a connecting line, so that a fluid, which is received by the fluid chamber and is pressed out of the fluid chamber through the first cylinder orifice by means of the pressure exerted by the piston, arrives via the connecting line at the spray orifice and is expelled there. The spray gun is designed in particular for the expulsion of plant protectants.

It is known to expel liquids by means of what is known as a spray bottle. In this case, a pumping mechanism acts directly upon the liquid which is expelled through a nozzle. Further, in spray devices, it is known by means of a pumping mechanism to increase the air pressure in a chamber which receives the water to be expelled. When a trigger is then actuated, the water located in the chamber is sprayed outwards through a nozzle on account of the compressed air in the chamber.

EP 0 462 749 B1 discloses a spray gun which is actuated by means of a hand lever. The spray gun has a connection for a liquid supply, via which connection liquids which are under pressure are fed to the spray gun. At the outlet end of the spray gun, an outlet nozzle is provided for expelling liquid in a specific spray pattern. Between the connection for the liquid supply and the outlet nozzle, a control valve is provided which can be opened by means of a trigger.

EP 1 136 135 B1 describes a fluid pump dispenser with a piston mechanism. In this pump dispenser, the formation of droplets or drops of the product at the outlet orifice is avoided in that the product is drawn into the pump chamber at the start of each piston return stroke.

DE 196 12 524 A1 describes a spray gun which is designed particularly for the expulsion of medium- to high-viscosity liquids, such as, for example, pasty adhesives. The spray gun has a substance feed connection piece and a substance outflow connection piece. Between these, a piston chamber is arranged in which a piston can be moved back and forth. The piston is coupled to a switching lever. By the switching lever being actuated, the throughflow through the piston chamber can be closed and opened as a result of the movement of the piston. On the switching lever, a sensor switch is provided which is designed as an inductive proximity switch and which switches off substance transport when the switching lever approaches in a stipulated proximity state. In this case, the propulsive pressure of substance transport is reduced before the closure of substance transport takes place. This is intended to prevent material from continuing to flow.

Further, spray guns are known in which a liquid is atomized into small drops with the aid of a pressure difference. For example, the substance to be expelled can be sucked out of a container with the aid of a Venturi tube and then atomized. Spray guns of this type are used, for example, for the spraying of paints. In this case, it is also known to put the paint under pressure by means of a pump and to press it through a nozzle such that the paint is finely atomized.

Finally, U.S. Pat. No. 5,441,180 discloses a spray gun which is designed particularly for the expulsion of plant protectants. This spray gun comprises a reservoir for the plant protectant to be expelled. Further, the spray gun comprises a pivotable trigger by means of which a piston can be moved. As a result of the movement of the piston, the volume in a chamber in which the plant protectant to be expelled is located is reduced, so that the plant protectant is expelled. When the trigger is pivoted back again, the piston is moved in the opposite direction, so that the volume of the chamber increases. A vacuum is thereby generated which sucks the plant protectant back out of the expulsion orifice.

Plant protectants are usually applied in the form of liquid active substance preparations. These are provided, as a rule, by the dilution of commercially customary active substance concentrates, such as, for example, suspension concentrates (SC), oil dispersions (OD), capsule dispersions (CS), emulsifiable concentrates (EC), dispersible concentrates (DC), emulsions (EW, EO), suspoemulsion concentrates (SE), solution concentrates (SL), water-dispersible and water-soluble powders (WP and SP), and water-soluble and water-dispersible granulates (WG, SG) with or in water. In addition, products in the form of active substance solutions are also used, which contain the active substance in a concentration suitable for application, what are known as ULVs. Furthermore, in order to combat arthropodic pests, active substance-containing gels are often used, which, before being applied, are optionally diluted with water to the desired application concentration. Here and hereinafter, therefore, the term “plant protectant” is used both for liquid active substance formulations, including active substance-containing gel formulations, with an active substance concentration suitable for application, and for liquid active substance preparations, including diluted gel formulations, which are obtainable by the dilution of active substance concentrates.

When plant protectants are expelled or sprayed by means of a spray gun, it is especially important that the spray gun can be handled safely and simply. The spray gun should be suitable for mobile use, that is to say it should be capable of being carried easily by a person. Further, it is especially important that the expelled fluid, that is to say the plant protectant, can be metered very accurately. Finally, the plant protectant should be capable of being applied exactly to a desired area from a specific distance by means of the spray gun. In this case, it should be ensured that, during the expulsion operation, no plant protectant can infiltrate into regions which should not come into contact with the plant protectant. In particular, it should be ensured that there is no possibility for the user to come into contact with the plant protectant. Moreover, dripping at the end of the expulsion operation should be avoided. The spray gun should, in particular, also be suitable for the application of active substance-containing gels, for example active substance-containing gels for combating arthropodic pests, and should allow directed application, for example in the form of spots or strips/strands. Moreover, the spray gun should be insensitive to inhomogeneities of the liquid plant protectant, such as may occur, for example, during the provision of the active substance preparation used for application, when the commercially available active substance concentrates have been diluted with or in water to the concentration desired for application.

The object on which the present invention is based is to provide a spray gun of the type initially mentioned, in which a coherent spray jet which reaches its target area completely is generated by means of the expulsion operation. Furthermore, an outflow of the fluid after the conclusion of the expulsion operation, that is to say a dripping of fluid, is to be prevented.

This object is achieved, according to the invention, by means of a spray gun having the features of claim 1. Advantageous refinements and developments may be gathered from the dependent claims.

The spray gun according to the invention is defined in that a fluid valve is arranged in the connecting line. Furthermore, in the cylinder a sensor is provided, by means of which a defined position of the piston, in which position fluid is still located in the fluid chamber during the expulsion operation, can be detected. Moreover, the fluid valve can be actuated by means of the sensor, the fluid valve being closed by means of the sensor when the defined position of the piston has been detected.

A spray gun is understood in the context of the invention to mean an appliance by means of which a fluid can be expelled, squirted, sprayed or atomized through an orifice. However, in particular, upon outflow a fluid jet can be generated by means of the spray gun according to the invention.

The spray gun according to the invention has a piston metering or piston pumping device. A fluid located in the fluid chamber is pressed out of the cylinder as a result of the movement of the piston in the latter. In such piston metering or piston pumping devices, the problem often arises that at the end of expulsion operation, when there is scarcely any more fluid in the fluid chamber, the pressure by means of which the fluid is expelled drops. The result of this pressure drop is that the expelled fluid jet stalls. The fluid quantity last expelled no longer possesses the same expulsion velocity as fluid volumes previously expelled, and therefore the fluid expelled at the end no longer arrives at the target in the same way as the previous fluid volumes. As a result of this, part of the expelled fluid jet falls onto a region between the target area and the spray gun. This presents a particular disadvantage when plant protectants are expelled by means of the spray gun.

In the spray gun according to the invention, this drop in velocity at the end of fluid expulsion can be prevented. The sensor ensures that the fluid valve is closed when the maximum pressure is still exerted by the piston upon the remaining fluid in the fluid chamber. Even the fluid quantity last expelled therefore also possesses the same expulsion velocity as the fluid volumes previously expelled. A coherent fluid jet can thus be generated, in which the entire expelled fluid has essentially the same velocity, so that the entire fluid quantity expelled during the expulsion operation reaches the desired target area. In particular, no drop in expulsion velocity occurs at the end of the expulsion operation, thus ensuring that no regions between the target of the expulsion operation and the spray orifice of the spray gun come into contact with the expelled fluid. This is advantageous particularly when the expelled fluid is a plant protectant, in particular a liquid, in particular gel-like, high-viscosity plant protectant.

The defined position of the piston in which the sensor closes the fluid valve is selected, in particular, such that there is still sufficient fluid in the fluid chamber to ensure that a pressure drop has not yet occurred at the spray orifice at the end of the expulsion operation. In particular, in this position, the piston has not yet reached its end position in the cylinder in which it butts against a cylinder wall.

In one refinement of the spray gun according to the invention, the defined position of the piston is detected by the sensor by means of a magnetic field generated or varied by the piston. For example, a permanent magnet may be integrated into the piston, which permanent magnet generates a magnetic field of which the field strength at the location of the sensor depends on the position of the piston. If the field strength of the magnetic field at the sensor overshoots or undershoots the specific limit value, the state of the sensor changes. In the spray gun according to the invention, this change of state is utilized in order to bring about a closing of the fluid valve. The limit value for the field strength of the magnetic field is in this case fixed such that the piston is in this case in the desired position within the cylinder in which a pressure drop does not yet occur during the expulsion operation.

The sensor comprises, in particular, what is known as a reed contact. In a reed contact, an electrical contact is closed when the field strength of the magnetic field at the location of the sensor overshoots a limit value.

Thus, during the expulsion operation, the sensor of the spray gun according to the invention detects the position of the piston by means of a measurement value which depends directly on the position of the piston in the cylinder. The position of the piston in the cylinder can thereby be detected with high accuracy. As a result of the subsequent electronic processing of the signal generated by the sensor, the expulsion operation can be terminated with high precision, with the result that a pressure drop at the end of the expulsion operation is avoided.

In the spray gun according to the invention, during the expulsion operation pressure is exerted by the piston upon the fluid located in the fluid chamber. In order to exert this pressure upon the fluid by means of the piston, a force must act upon the piston. For this purpose, for example, the cylinder may have formed in it a pressure chamber, in which is formed at least one second cylinder orifice which is connected to a first connection for a compressed gas line, in particular a compressed air line. Thus, compressed gas can enter the pressure chamber via the second cylinder orifice. When the pressure in the pressure chamber exceeds the pressure in the fluid chamber, the movable piston is pressed in the direction of the fluid chamber in which the fluid is located. Thus, the volume of the pressure chamber is increased and the volume of the fluid chamber reduced, with the result that the fluid is pressed out through the first cylinder orifice. At the same time, by the first connection being connected to the compressed gas line, the pressure can be kept constant in the pressure chamber, so that a constant pressure is exerted upon the fluid in the fluid chamber by the piston during the expulsion operation.

According to a further refinement of the spray gun according to the invention, said spray gun has additionally or alternatively a compression spring which acts between a stop and the piston. The compression spring can exert upon the piston a force in the direction of a reduction in the volume of the fluid chamber. In this case, it is possible to design the spray gun such that no pressure chamber is formed and the cylinder is not connected to the compressed gas line. In this case, the piston pressure is generated solely by the compression spring. The pressure exerted upon the fluid during the filling of the fluid chamber must then optionally exceed the pressure exerted by the compression spring, so that, during the filling of the fluid chamber with the fluid, the compression spring is compressed and the volume of the fluid chamber increases. Further, it is possible, however, to provide the compression spring in addition to the pressure chamber. In this case, the compression spring assists the pressure upon the piston which is exerted by the compressed gas in the pressure chamber.

Furthermore, the spray gun according to the invention may have a regulating device, by means of which the movement of the piston in the cylinder and, consequently, the maximum volume of the fluid chamber can be limited. Thus, by means of the regulating device, the fluid volume expelled during the expulsion operation can be set exactly.

According to another refinement, the sensor is adjustable in the longitudinal direction of the cylinder. In this case, the expelled fluid volume can be set by the position of the sensor being set in relation to the cylinder.

According to one development of the spray gun according to the invention, the latter has a second connection for a fluid reservoir. The fluid reservoir may be integrated into the spray gun. If, however, the fluid reservoir is to receive relatively large fluid quantities, the fluid reservoir is provided separately from the spray gun, so that the fluid is fed to the spray gun via the second connection. This second connection may be connected to a further cylinder orifice, via which fluid can be fed to the fluid chamber. It is also possible, however, that the second connection is connected to the first cylinder orifice, so that the fluid can be conveyed into the fluid chamber via the second connection and the first cylinder orifice. Thus, the fluid then flows through the first cylinder orifice both into the fluid chamber of the cylinder and out of this fluid chamber.

In this case, it is possible, furthermore, to design the fluid valve as a first 3/2-way valve, in which, in a first setting, a passage of fluid from the first cylinder orifice to the spray orifice is provided, and, in a second setting, a passage of fluid from the second connection to the first cylinder orifice is provided.

A 3/2-way valve is understood to be a valve with three connections and two switch settings. The fluid reservoir or the second connection, the spray orifice and the first cylinder orifice are connected to the three connections of the valve. In the first setting of the valve, passage from the first cylinder orifice to the spray orifice is provided, passage from the fluid reservoir or the second connection to the first cylinder orifice being closed. In the second setting of the valve, a passage of fluid from the fluid reservoir or the second connection to the first cylinder orifice is provided, the passage from the first cylinder orifice to the spray orifice being closed. Thus, by means of the first 3/2-way valve, both fluid transport to the spray orifice during the expulsion operation and fluid transport for filling the fluid chamber of the cylinder for the fluid are carried out.

Further, in the spray gun according to the invention, a compressed gas valve designed as a second 3/2-way valve may be arranged between the first connection, via which a compressed gas can be fed to the spray gun, and the second cylinder orifice. In the first setting of this compressed gas valve, a passage of compressed gas from the first connection to the second cylinder orifice is provided. In the second setting of the compressed gas valve, a reduction in the pressure of the compressed gas within the pressure chamber is made possible. For example, in the second setting, passage of compressed gas from the second cylinder orifice into the open may be provided.

According to a development of the spray gun according to the invention, the fluid reservoir is connected, on the one hand, to a device for the provision of compressed gas, move particularly compressed air. The device may be, for example, a compressed air tank, a compressor and a hand pump. However, the fluid may also be put under pressure directly, for example by a pump. On the other hand, the fluid reservoir is connected to the first connection of the compressed gas valve via a line. A connection from the compressed gas valve to the fluid reservoir is thus provided. This connection may be integrated into the spray gun or be formed separately from the spray gun. In the second setting of the compressed gas valve, the pressure chamber can thus be acted upon with compressed gas. Furthermore, the fluid reservoir is acted upon with compressed gas in order to effect fluid transport for filling the fluid chamber of the cylinder.

According to one development of the spray gun according to the invention, the sensor is coupled to the first and the second 3/2-way valve. In this case, the sensor switches the first and the second 3/2-way valve into the second setting when the piston is in the defined position, so that the expulsion of fluid through the spray orifice is interrupted and fluid is conveyed by means of the compressed gas from the fluid reservoir into the fluid chamber via the first 3/2-way valve. After the sensor has terminated the expulsion operation, the fluid chamber of the cylinder is thus refilled with fluid automatically via the two 3/2-way valves. Switching of the valves takes place, in particular, electronically. Preferably, the two valves are changed over simultaneously when the piston is in the defined position, or initially the first 3/2-way valve for the fluid and shortly thereafter the second 3/2-way valve for the compressed gas are changed over.

Moreover, the spray gun has a trigger. The expulsion operation is initiated by this trigger. According to one design of the spray gun according to the invention, the trigger is coupled to the first and the second 3/2-way valve. When the trigger is actuated, it switches the first and the second 3/2-way valve into the first setting, so that the piston is moved by the compressed gas in the pressure chamber such that the volume of the fluid chamber is reduced and fluid is thereby expelled through the spray orifice. After the trigger has been actuated, in this case, preferably, initially the second 3/2-way valve for the compressed gas and shortly thereafter the first 3/2-way valve for the fluid are changed over. It can be reliably ensured that, even at the start of the expulsion operation, the maximum pressure is exerted upon the fluid located in the fluid chamber.

The trigger is, in particular, an electronic trigger, upon the actuation of which a control signal is transmitted. Further, the fluid valve and/or the compressed gas valve may be actuable electromagnetically. In this case, the spray gun may comprise an electronic control device which is data-coupled to the sensor, to the fluid valve and/or to the compressed gas valve. The fluid valve and/or the compressed gas valve can then be actuated as a function of a signal generated by the sensor. These actuations are controlled by the electronic control device. For this purpose, the control device may comprise, in particular, a relay or a microprocessor.

By virtue of the electronic control of the valves and the electronic trigger for the spray gun, it is possible to design the mechanical set-up of the spray gun very simply. A reduction in the weight of the spray gun can thereby be achieved, this being advantageous particularly in the case of mobile use of the spray gun. What is achieved by the electronic control of the valves is that fluid expulsion can be controlled with high accuracy, this being important particularly when plant protectants are being expelled.

In an alternative refinement of the spray gun according to the invention, a first and a second fluid chamber are formed in the cylinder. In the first fluid chamber, at least one first cylinder orifice is formed. In the second fluid chamber, at least one second cylinder orifice is formed. In this alternative refinement, the fluid received by the first fluid chamber can be pressed out by fluid being pressed under pressure into the second fluid chamber, with the result that a force is exerted upon the piston in the direction of a reduction in the size of the first fluid chamber. Conversely, the fluid received by the second fluid chamber can be pressed out by fluid being pressed under pressure into the first fluid chamber, with the result that force is exerted upon the piston in the direction of a reduction in the size of the second fluid chamber. In this refinement of the spray gun according to the invention, therefore, the pressure chamber fillable with compressed gas has been replaced by a fluid chamber. In this case, pressure is exerted upon the piston not by a compressed gas, but by the fluid located in the other fluid chamber in each case, so that the fluid is expelled alternately out of the two fluid chambers. The advantage of this refinement is that the intermissions between two expulsion operations of the spray gun are very much shorter, since it is no longer necessary to wait until the fluid chamber is refilled in order to start the next fluid expulsion. To be precise, the filling of one fluid chamber causes the expulsion of fluid via the other fluid chamber.

According to a development of this refinement of the spray gun according to the invention, a first sensor is provided in the first fluid chamber and a second sensor is provided in the second fluid chamber. As explained above, a defined position of the piston, in which fluid is still located in the respective fluid chamber during the expulsion operation, can be detected by the sensor. Furthermore, a fluid valve, via which the fluid of the respective fluid chamber is expelled, can be actuated by the sensor. The respective fluid valve is closed by means of the sensor when the defined position of the piston has been detected.

According to a development of this refinement of the spray gun according to the invention, the sensors are adjustable in the longitudinal direction of the cylinder. In this case, the expelled fluid volume can be set by the position of the sensors being set in relation to the cylinder.

According to a further alternative refinement of the spray gun according to the invention, this comprises a first and a second cylinder. In the first cylinder, a first fluid chamber with a first cylinder orifice is formed, and, in the second cylinder, a second fluid chamber with a second cylinder orifice is formed. Furthermore, a first pressure chamber is formed in the first cylinder and a second pressure chamber is formed in the second cylinder, the first and the second pressure chamber communicating with one another and comprising a non-compressible working fluid. The first fluid chamber is separated from the first pressure chamber by a first piston. The second fluid chamber is separated from the second pressure chamber by a second piston, the volume of the first fluid chamber decreasing when the volume of the second fluid chamber increases. Conversely, the volume of the first fluid chamber increases when the volume of the second fluid chamber decreases. According to this refinement, the fluid received by the first fluid chamber can be pressed out by fluid being pressed under pressure into the second fluid chamber, force being exerted upon the second piston and being transmitted to the first piston via the working fluid. Conversely, the fluid received by the second fluid chamber can be pressed out by fluid being pressed under pressure into the first fluid chamber, with the result that force is exerted upon the first piston and is transmitted to the second piston via the working fluid.

In this refinement, the fluid valve is coupled to the first cylinder orifice and the second cylinder orifice, a passage of fluid to the spray orifice being capable of being effected only in each case to one cylinder orifice. Further, preferably, the fluid valve can also be shut off completely.

Further, in particular, the first cylinder is assigned a first sensor, by means of which a defined position of the first piston, in which fluid is still located in the first fluid chamber during the expulsion operation, can be detected. The fluid valve can be actuated by the first sensor, the fluid valve being closed by means of the first sensor for passage from the first cylinder orifice to the spray orifice when the defined position of the first piston in the first cylinder has been detected. Furthermore, for the second cylinder, a second sensor is provided, by means of which a defined position of the second piston, in which fluid is still located in the second fluid chamber during the expulsion operation, can be detected. The fluid valve can be actuated by the second sensor, the fluid valve being closed by means of the second sensor for passage from the second cylinder orifice to the spray orifice when the defined position of the second piston has been detected.

In this refinement, too, the sensors may be adjustable in the longitudinal direction of the respective cylinder, so that the expelled fluid volume can be set by the positions of the sensors being set in relation to the cylinders. Alternatively or additionally, in this refinement, the volume of the working fluid in the two communicating pressure chambers may also be varied. Thus, the maximum volume of the two fluid chambers and, consequently, the expelled fluid volume can be set.

In this further refinement, too, the time interval between two expulsion operations can be shortened, since the filling of one fluid chamber causes the operation of expelling the fluid out of the other fluid chamber.

The spray gun according to the invention is suitable for the application of fluids (liquids). Fluids suitable for application have, as a rule, a dynamic viscosity in the range of 0.5 to 1000 mPa·s, often 0.8 to 500 mPa·s, (determined by Brookfield's rotary viscometry according to DIN53019 (ISO 3219) at 25° C. and with a shear gradient of 100 s⁻¹). Suitable fluids may be Newtonian liquids or non-Newtonian liquid, the latter preferably being shear-diluting, that is to say viscoelastic or pseudoplastic non-Newtonian fluids.

According to one embodiment, the spray gun according to the invention is designed for fluids of low viscosity, that is to say, in particular, for liquids with a viscosity of no more than 50 mPa·s, in particular no more than 30 mPa·s, for example 0.5 to 50 mPa·s, in particular 0.8 to 20 mPa·s (determined by Brookfield's rotary viscometry according to DIN53019 (ISO 3219) at 25° C. and with a shear gradient of 100 s⁻¹). These include both organic liquids, particularly solutions of active substances, for example plant protection active substances, in organic solvents, and aqueous liquids, for example aqueous active substance solutions, but also emulsions, suspoemulsions and suspensions, in which the active substance, in particular the plant protection active substance, is present in dispersed form in a coherent aqueous phase.

The spray orifice may be designed such that the fluid is atomized, but a liquid jet is preferably generated. For this purpose, the spray orifice is preferably surrounded by a spray nozzle which, when the liquid or aqueous solution passes through it, generates a liquid jet, that is to say, in particular, the liquid or solution is not atomized.

According to a further embodiment, the spray gun according to the invention is designed for gel-like fluids which, in contrast to fluids of low viscosity, have increased viscosity. Gel-like fluids of this type are usually viscoelastic and, as a rule, have at 25° C. a zero shear viscosity η₀ of at least 100 mPa·s and, in particular, of at least 200 mPa·s. However, the dynamic viscosity of the gel-like fluid will usually not overshoot a value of 1000 mPa·s, in particular of 500 mPa·s and especially of 300 mPa·s (determined by Brookfield's rotary viscometry according to DIN53019 (ISO 3219) at 25° C. and with a shear gradient of 100 s⁻¹) and, in particular, lies in the range of 30 to 1000 mPa·s, often in the range of 30 to 800 mPa·s and, in particular, in the range of 50 to 500 mPa·s. Preferably, at 25° C., the limit value of the viscosity in the case of an infinite shear gradient η_{∞} is not more than 300 mPa·s and, in particular, not more than 200 mPa·s. The gel-like liquid may be a gel formulation which contains the active substance in the concentration required for application. It is, in particular, a liquid which is obtained by a gel formulation being diluted to the concentration required for application. The spray orifice is in this case preferably surrounded by a spray nozzle which, when the gel-like fluid passes through it, generates a liquid jet, that is to say the gel-like fluid can be applied in a punctiform manner, that is to say in the form of drops, or linearly, that is to say in the form of strands or strips. Examples of suitable spray nozzles are conical nozzles without a baffle plate, jet nozzles or hole nozzles.

Examples of gel formulations which can be applied in optionally diluted form by means of the spray gun according to the invention are, in particular, those gel formulations which are used for combating arthropodic pests. Gel formulations of this type are known, for example, from WO 2008/031870. These gels, as a rule, typically comprise at least one active substance which is active against arthropodic pests, such as insects or arachnids (Arachnida). In addition, these gels typically comprise water, at least one thickener or gel former and optionally one or more lures and/or feeding stimulants.

The spray guns described above are suitable particularly for the application of liquids which comprise one or more plant protection active substances which are dissolved or dispersed, that is to say suspended or emulsified form. The active substance concentration in these liquids typically lies in the range of 0.001 to 10 g/l. The use of the spray gun is in this respect not restricted to specific plant protection active substances and is suitable for the application of all active substances which are usually employed in plant protection and are used in the form of liquid, including low-viscosity or gel-like application forms. These include basically all plant protection active substances from the group of herbicides, herbicide safeners, fungicides, insecticides, acaricides, nematicides, molluscicides, virucides, bactericides, algaecides, growth regulators, pheromones, above all sexual pheromones (mating disruptors) and activators as well as fertilizers.

The present invention relates, further, to the use of the above-described spray gun for the expulsion of the following liquid products:
Aqueous active substance preparations of active substances, in particular plant protection active substances, which are obtainable by dilution of active substance concentrates with water to the desired application concentration and which comprise one or more of the abovementioned plant protection active substances in dissolved or dispersed form.
Non-aqueous solutions or suspensions of active substances, in particular plant protection active substances, which comprise the active substance in a concentration suitable for application.
Aqueous gel-like liquids which comprise one or more active substances, in particular plant protection active substances, especially from the group of insecticides, acaricides or pheromones, and which, with suitable viscosity, are applied as such or optionally after dilution with water to the desired application concentration, which comprise one or more of the abovementioned plant protection active substances in dissolved or dispersed form, and also water, at least one thickener or gel former and optionally one or more lures and/or feeding stimulants.

The spray gun according to the invention can be used in the most diverse possible sectors of plant protection, in particular for the treatment of plants, especially of their leaves (leaf application), but also for the treatment of propagatable plant materials (seeds). The spray gun according to the invention is also suitable for the treatment of inanimate materials, in particular of inanimate organic materials, such as wood, straw, paper, leather, textiles or plastic, which are infested with harmful organisms or are to be protected from infection with harmful organisms, such as fungae or insects, with a liquid active substance composition, which contain one or more suitable active substances.

Moreover, such materials can be hung up as bait and be charged or recharged with a suitable formulation by means of the spray gun.

The plant protectant is, in particular, not atomized by the spray gun, as in conventional application, but is applied to the target area in the form of a compact jet. In this case, application at a single point may take place (spot application) or may cover a strip arising from forward movement. Due to the consistency of the plant protectant, the applied quantities remain adhering to the target area. The plant protectant therefore has, in particular, a gel consistency.

Exemplary embodiments of the spray gun according to the invention are explained in detail hereinafter with reference to the drawings in which:

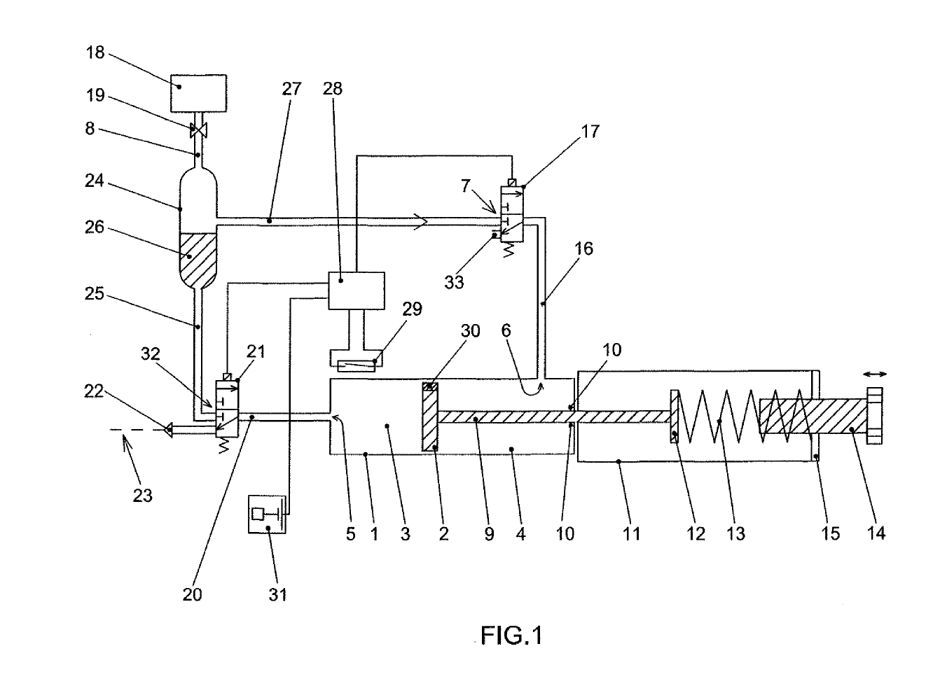

FIG. 1 shows diagrammatically the set-up of a first exemplary embodiment of the spray gun according to the invention and the coupling of this spray gun to a fluid reservoir and to a compressed gas container,

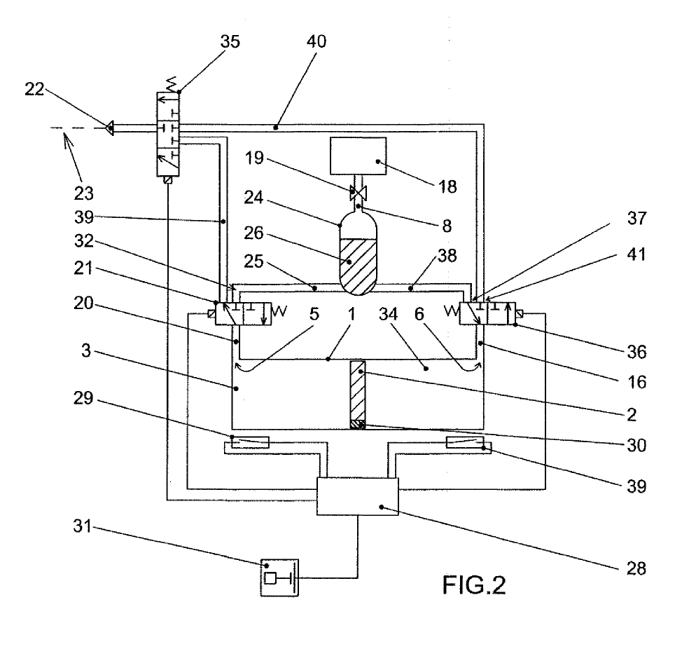

FIG. 2 shows diagrammatically the set-up of a second exemplary embodiment of the spray gun according to the invention and the coupling of this spray gun to a fluid reservoir, and

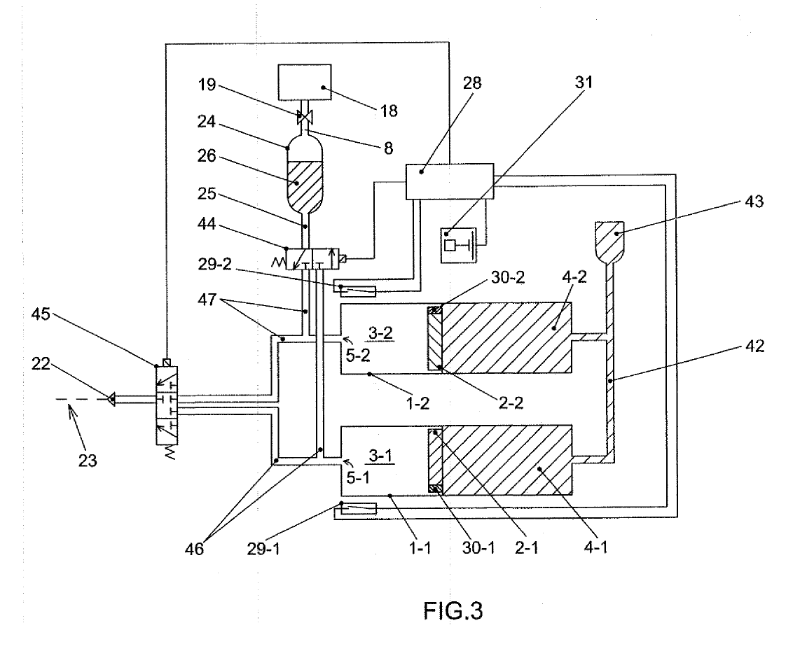

FIG. 3 shows diagrammatically the set-up of a third exemplary embodiment of the spray gun according to the invention and the coupling of this spray gun to a fluid reservoir.

The first exemplary embodiment of the spray gun according to the invention is explained first with reference to FIG. 1.

The spray gun comprises a piston metering or piston pumping device, which has a cylinder 1 and a piston 2 which is mounted movably in the cylinder 1. The cylinder 1 is subdivided, fluid-tight, by the piston 2 into a fluid chamber 3 for the fluid to be expelled and a pressure chamber 4. In the fluid chamber 3, a first cylinder orifice 5 is provided, through which the fluid chamber 3 can be filled with fluid and through which, moreover, fluid is pressed out of the fluid chamber 3 during the expulsion operation. In the pressure chamber 4, in the cylinder 1 a second cylinder orifice 6 is formed, which is connected to a first connection 7 for a compressed gas line 8, as is explained later.

Further, in the cylinder 1 an orifice is provided, through which the shank 9 of the piston 2 passes and in which this shank 9 is mounted, gas-tight, in a bearing 10. Mounting in this case takes place in such a way that the piston 2 can be moved back and forth in the longitudinal direction of the cylinder 1, so that the volume of the fluid chamber 3 and of the pressure chamber 4 is varied as a result of the movement of the piston 2. Furthermore, seals are provided in the mounting, so that no compressed gas can escape from the pressure chamber 4 through this orifice.

That part of the shank 9 of the piston 2 which passes through the further orifice in the cylinder 1 extends into a further cylinder 11. The rear end of the piston 2 is provided with the plate 12 which, on the one hand, indicates the position of the piston 2 to the user. For this purpose, the cylinder 11 is at least partially of transparent design. On the other hand, the plate 12 serves for coupling the piston 2 to a compression spring 13 which is coupled, on the one hand, to the plate 12 and, on the other hand, to a closing-off wall 15 of the cylinder 11. The compression spring 13 exerts upon the piston 2 a force which acts in the direction of a reduction in the volume of the fluid chamber 3.

Furthermore, at the rear end of the cylinder 11, near the closing-off wall 15, a regulating device is provided which limits the movement of the piston 2 in the direction of an increase in the volume of the fluid chamber 3. The maximum volume of the fluid chamber 3 is thus set by means of the regulating device. In the present exemplary embodiment, the regulating device is designed as a screw 14 which is received in an internal thread of the closing-off wall 15 of the cylinder 11. By the screw 14 being rotated in this internal thread, the length of that portion of the screw 14 which extends into the cylinder 11 can be set. When, as is explained later, the piston 2 moves in the direction of the screw 14 during the filling of the fluid chamber 3 with fluid, this movement of the piston 2 is limited by an abutment of the plate 12 against the screw 14.

The volume of the cylinder may, for example, lie in a range of 1 ml to 500 ml, in particular in a range of 5 ml to 50 ml. In the present exemplary embodiment, the cylinder 1 has a diameter of 25 mm. The maximum length over which the piston 2 is moved in the cylinder 1 in the longitudinal direction during an expulsion operation is 25 mm. In this case, a fluid volume of a maximum of 12.27 cm³ is pressed out through the first cylinder orifice 5. The movement of the piston 2 of 1 mm in the direction of the of the first cylinder orifice 5 thus has the effect that 0.49 cm³ of fluid is conveyed through the first cylinder orifice 5.

In order to press the piston 2 in the direction of the first cylinder orifice 5, that is to say to the left in FIG. 1, the gas pressure in the pressure chamber 4 is increased via the second cylinder orifice 6. In the present exemplary embodiment, compressed air is introduced into the pressure chamber 4 via the line 16. The line 16 is connected to a compressed gas valve 17, the function of which is explained later.

The air pressure in the pressure chamber 4 is increased until the force exerted upon the piston 2 by the compressed air and, optionally, the compression spring 13 in the direction of the first cylinder orifice 5 exceeds the force which is exerted upon the piston 2 in the opposite direction by the fluid located in the fluid chamber 3. It is pointed out that this propulsive pressure for the piston 2 may also be exerted only by the compressed gas in the pressure chamber 4, only by the compression spring 13 or both by the compressed gas in the pressure chamber 4 and by the compression spring 13.

The first cylinder orifice 5 is connected via a line 20 and a fluid valve 21 to a spray nozzle 22 which provides a spray orifice. The fluid expelled by the spray gun flows out through the spray orifice in a fluid jet 23. The pressure exerted upon the fluid may, for example, be so high that the emerging fluid jet can be shot onto a target area over a distance of two to three meters. The pressure exerted upon the fluid may, for example, lie in a range of 2 bar to 6 bar.

The fluid to be expelled is conveyed into the fluid chamber 3 as follows:

For a fluid stock 26, a fluid reservoir 24 is provided which is connected to a connection 32 of the spray gun via a line 25. This connection 32 is coupled to a connection of the fluid valve 21 which is designed as a 3/2-way valve. The further connections of the 3/2-way valve are connected to the first cylinder orifice 5 and to the spray nozzle 22. In the first setting of the fluid valve 21, a passage of fluid from the first cylinder orifice 5 to the spray nozzle 22 is provided. In a second setting of the fluid valve 21, however, a passage of fluid from the fluid reservoir 24 via a line 25 through the fluid valve 21 to the line 20 and finally to the first cylinder orifice 5 is provided. Thus, in the second setting of the fluid valve 21, a fluid 26 which is located in the fluid reservoir 24 can be conveyed into the fluid chamber 3. The fluid 26 can in this case enter the fluid chamber 3 as a result of gravity or by means of a pump. In the present exemplary embodiment, however, the fluid reservoir 24 is acted upon with compressed air which presses the fluid 26 into the fluid chamber 3. For this purpose, the fluid reservoir 24 is connected via a line 8 to a device 18 for the provision of compressed air. The device 18 may, for example, be a compressed air tank, a compressor and a hand pump. Furthermore, a shut-off valve 19 may optionally be arranged in the line 8.

Further, the fluid reservoir 24 is connected via a line 27 to the first connection 7 of the compressed gas valve 17, which is also designed as a 3/2-way valve. In the first setting of this compressed gas valve 17, passage of compressed gas from the compressed air line 8 via the first connection 7 through the compressed gas valve 17 and the line 16 to the second cylinder orifice 6 into the pressure chamber 4 is provided. In the second setting of the compressed gas valve 17, by contrast, this passage is closed and a passage of compressed gas from the line 16 via a third connection 33 into the open is provided. Thus, in the second setting, the pressure in the pressure chamber 4 can be reduced.

The fluid valve 21 and the compressed gas valve 17 may be actuable electromagnetically. They are connected to a control device 28 which can actuate them. In this case, as described above, the valves 17 and 21 can be changed over from the first setting into the second setting, and vice versa. For this purpose, the control device 28 may, for example, comprise a relay or a microprocessor.

Further, the control device 28 is connected to a sensor 29. The sensor 29 may, for example, be designed as a reed switch or comprise a reed contact. This contact is closed when the field strength of a magnetic field at the sensor 29 overshoots a limit value. The control device 28 detects whether the reed contact of the sensor 29 is closed or open.

The position of the piston 2 in the cylinder 1 can be detected by means of the sensor 29. In the spray gun according to the invention, a specific position of the piston 2 within the cylinder 1, in which position the expulsion operation is to be terminated, is defined. Exactly in this defined position of the piston 2, the sensor 29 changes its state. This is detected by the control device 28. In order to bring about this change of state of the sensor 29, a permanent magnet 30 is integrated in the piston 2. This permanent magnet 30 generates a magnetic field, of which the field strength at the location of the sensor 29 depends on the position of the piston 2. When the piston 2 is in the defined position explained above, the magnetic field generated by the permanent magnet 30 causes a change of state in the sensor 29. When such a change of state is detected by the control device 28, the control device 28 actuates at least the fluid valve 21 in such a way that the fluid passage from the line 20 to the spray nozzle 22 is closed and therefore the expulsion of fluid through the spray nozzle 22 is interrupted. The fluid valve 21 is thus switched into the second setting. The position of the piston 2 in which this interruption takes place is in this case selected such that the full pressure is still exerted upon the fluid in the fluid chamber 3 by the piston 2 before the interruption of the expulsion. What is achieved thereby is that the expelled fluid jet 23 is still expelled at the same velocity up to the end of the expulsion operation, so that the fluid jet 23 is expelled coherently as far as the desired target.

In the defined position of the piston 2, there is, in particular, still sufficient fluid located in the fluid chamber 3 in order to transmit the pressure exerted upon the fluid by the piston 2 through the line 20 to the spray nozzle 22. With the above-specified dimensions of the cylinder 1, when the piston 2 is in the defined position there is, in particular, still 1 ml to 1.5 ml of fluid in the fluid chamber 3.

Further, the control device 28 is connected to a trigger 31 which is designed as an electrical touch-contact switch. When the trigger 31 is actuated, the control device 28, on the one hand, switches the fluid valve 21 into the first setting, in which fluid passes through from the first cylinder orifice 5 to the spray nozzle 22, and, on the other hand, switches the compressed gas valve 21 into the first setting, so that the pressure chamber 4 is acted upon with compressed air and fluid expulsion is initiated.

The filling of the fluid chamber 3 and fluid expulsion in the first exemplary embodiment of the spray nozzle are explained in detail hereinafter:

When the fluid chamber 3 is being filled with fluid, both the fluid valve 21 and the compressed gas valve 17 are in the second setting. In this case, the fluid 26 in the fluid reservoir 24 is conveyed through the line 25 and through the fluid valve 21 via the line 20 into the fluid chamber 3 of the cylinder 1. The pressure exerted by the compressed air is in this case so high that the piston 2 is moved to the right in FIG. 1, specifically counter to the force which is exerted by the compression spring 13. During the movement of the piston 2, the air in the pressure chamber 4 escapes through the line 16, the compressed gas valve 17 and the third connection 33 outwards. The fluid chamber 3 can be filled with fluid, the volume of the fluid chamber 3 increasing as a result of the movement of the piston 2, until the plate 12 of the piston 2 butts against the screw 14. When the piston 2 is at this stop, the maximum set volume of the fluid chamber 3 is reached and the fluid chamber 3 is filled with fluid completely.

If, then, the trigger 31 is actuated by a user, a corresponding signal is transmitted to the control device 28. The control device 28 thereupon switches the compressed gas valve 17 and the fluid valve 21 into the first setting. In this setting, the fluid feed from the fluid reservoir 24 is shut off, but the passage of fluid from the fluid chamber 3 to the spray nozzle 22 is opened. Moreover, simultaneously or preferably shortly beforehand, the passage of compressed gas from the compressed air line 8 into the pressure chamber 4 is opened, so that compressed air is introduced into the pressure chamber 4. Due to the compressed air in the pressure chamber 4 and due to the compression spring 13, such a high force is exerted upon the piston 2 that the latter is moved to the left in FIG. 1, that is to say in the direction of a reduction in the volume of the fluid chamber 3. During this movement of the piston 2, the fluid located in the fluid chamber 3 is expelled through the line 20, the fluid valve 21 and the spray nozzle 22 in a fluid jet 23. In this case, during the entire expulsion operation, essentially a constant pressure is maintained in the fluid in the fluid chamber 3 by the piston 2.

When the piston 2 then reaches the defined position explained above, the permanent magnet 30 generates at the sensor 29 a magnetic field of a field strength which leads to a change of state of the sensor 29. Such a change of state is detected by the control device 28, whereupon the control device 28 switches the fluid valve 21 and the compressed gas valve 17 in each case back into the second setting again. The changeover of the two valves 17 and 21 may take place simultaneously. Furthermore, it is possible for the fluid valve 21 to be changed over first, and only shortly thereafter the compressed gas valve 17. What is ensured in each case is that, immediately before the changeover of the fluid valve 21, the full force is still exerted by the piston 2 upon the fluid located in the fluid chamber 3.

After the two valves 17 and 21 have been brought into the second setting, the fluid chamber 3 is filled with fluid again automatically for the next expulsion operation, as explained above.

The second exemplary embodiment of the spray gun according to the invention is explained hereinafter with reference to FIG. 2:

In the second exemplary embodiment, parts which have the same function as in the first exemplary embodiment are designated by the same reference symbols. The function of these parts is also the same as in the first exemplary embodiment, and therefore the description of these parts is not repeated in detail.

The second exemplary embodiment of the spray gun differs from the first exemplary embodiment particularly in that the pressure chamber 4 of the first exemplary embodiment has been converted into a second fluid chamber 34. A first fluid chamber 3 and a second fluid chamber 34, which are separated from one another by the movable piston 2, are thus formed in the cylinder 1. Further, the compression spring 13 of the first exemplary embodiment has been omitted.

As in the first exemplary embodiment, the first fluid chamber 3 is connected via the first cylinder orifice 5 and a line 20 to a fluid valve 21 which is designed in this second exemplary embodiment as a first fluid valve 21. The first fluid valve 21 is also designed as a 3/2-way valve. As in the first exemplary embodiment, a connection of the first fluid valve 21 is connected to the spray nozzle 22. In the second exemplary embodiment, however, a third fluid valve 35 is arranged between the connection of the first fluid valve 21 and the spray nozzle 22, as is explained later.

As in the first exemplary embodiment, the connection 32 of the first fluid valve 21 is connected to a fluid reservoir 24 in which fluid 26 is located. As in the first exemplary embodiment, the fluid reservoir 24 can be acted upon with compressed air by means of the compressed air line 8, the shut-off valve 19 and the device 18 for the provision of compressed air. However, in all the exemplary embodiments, the fluid may also be put under pressure in another way, in order to move the piston 2, as explained later. For example, a pump may be used. In this case, a bypass may also be provided, via which the fluid passes back into the reservoir when the cylinder 1 is not filled, because at least one fluid valve or a plurality of fluid valves is or are closed.

Unlike in the first exemplary embodiment, in the second exemplary embodiment the second cylinder orifice 6, which is in this case arranged at the second fluid chamber 34, is connected to a second fluid valve 36 via the line 16. This second fluid valve, too, is designed as a 3/2-way valve. The connection 37 of the second fluid valve 36 is connected to the fluid reservoir 24 via a line 38. The other connection 41 of the second fluid valve 36 is connected to the spray nozzle 22 via the third fluid valve 35.

The third fluid valve 35 is designed as a 3/3-way valve with a shut-off middle setting. A passage from the line 39 to the spray nozzle 22 or from the line 40 to the spray nozzle 22 can thus be effected. Furthermore, both passages may be shut off.

As in the first exemplary embodiment, a sensor 29 designed as a reed switch is arranged in the first fluid chamber 3 and is designated in the second exemplary embodiment as a first sensor 29. When the permanent magnet 30 of the piston 2 is in the defined position explained with regard to the first exemplary embodiment, this permanent magnet 30 generates a magnetic field, of which the field strength at the location of the first sensor 29 causes the reed contact to be closed. This is detected by the control device 29.

In the second exemplary embodiment, however, in contrast to the first exemplary embodiment, a corresponding second sensor 39 is located in the second fluid chamber 34. The second sensor 39, too, comprises a reed contact. In the spray gun of the second exemplary embodiment, a further position of the piston 2 is defined, in which the expulsion operation is to be terminated, to be precise, in this case, the operation of expelling the fluid out of the second fluid chamber 34. The second sensor 39 is designed such that the reed contact is closed when the permanent magnet 30 of the piston 2 generates, in a correspondingly defined position, a magnetic field, of which the field strength at the location of the second sensor 39 overshoots the limit value for switching the reed contact. This change of state of the second sensor 39 is also detected by the control device 28.

Furthermore, the two sensors 29, 39 may be adjustable in the longitudinal direction of the cylinder 1. In this case, the fluid volume to be discharged can be adapted by the position of the sensors 29, 39 being varied.

The spraying operation with the spray gun according to the second exemplary embodiment is explained hereinafter:

Before the actual spraying operation, the cylinder 1 of the spray gun is filled with fluid 26 from the fluid reservoir 24. In this initial state, the control device 28 first activates the third fluid valve 35 such that the passages in the direction of the spray nozzle 22 are shut off, that is to say the third fluid valve 35 is in the middle setting. Thereupon, the first fluid valve 21 is activated by the control device 28 such that a fluid passage from the fluid reservoir 24 into the first fluid chamber 3 is created. If, then, the shut-off valve 19 is opened, the fluid reservoir 24 is acted upon with compressed air, so that fluid 26 flows via the line 25 through the first fluid valve 21 into the first fluid chamber 3. Alternatively, in this case, too, the fluid may be put under pressure, for example by means of a pump. Thus, in the illustration according to FIG. 2, the piston 2 is moved to the right until it butts against a stop (not illustrated). If, in this case, there is still air located in the second fluid chamber 34, an outlet valve for displacing this air may be provided. If fluid 26 is already located in the second fluid chamber 34, the second fluid valve 36 is activated by the control device 28 such that the fluid passage between the line 38 and the line 16 is opened, so that the fluid in the second fluid chamber 34 can flow back into the reservoir 24.

If, then, the trigger 31 is actuated by a user, the control device 28 switches the first fluid valve 21 for a passage of fluid from the line 20 into the line 39. The fluid passage from the line 20 into the line 25 is shut off. By contrast, the second fluid valve 36 is switched such that the fluid passage from the line 38 into the line 16 is opened, but the fluid passage from the line 16 into the line 40 is shut off. Furthermore, the control device 28 activates the third fluid valve 35 such that the fluid passage from the line 39 to the spray nozzle 22 is opened, but the fluid passage from the line 40 to the spray nozzle 22 is shut off. This switching of the three fluid valves 21, 36 and 35 has the effect that, by the fluid reservoir 24 being acted upon with compressed air, fluid 26 flows via the line 38 through the second fluid valve 36 into the second fluid chamber 34. The fluid in the second fluid chamber 34 exerts force upon the piston 2, so that the latter is pressed in the direction of a reduction in the volume of the first fluid chamber 3, to the left in the illustration according to FIG. 2. The fluid located in the first fluid chamber 3 is thus pressed through the first cylinder orifice 5 via the line 20, through the first fluid valve 21 via the line 39 and through the third fluid valve 35 to the spray nozzle 22 where it is expelled as a fluid jet 23.

The expulsion operation lasts until the magnetic field generated by the permanent magnet 30, at the location of the first sensor 29, exceeds a field strength which brings about a change of state of the first sensor 29, which is detected by the control device 28. As soon as this change of state has been detected, the control device 28 changes over the three fluid valves 29, 36 and 35 as follows: The first fluid valve 21 is switched such that the passage from the line 20 to the line 39 is shut off, but the passage from the line 25 to the line 20 is opened. The second fluid valve 36 is changed over such that the fluid passage from the line 38 into the line 16 is shut off, but the fluid passage from the line 16 into the line 40 is opened. Furthermore, the third fluid valve 35 is changed over such that it is brought into the completely shutting-off middle setting or that it is brought directly into a setting in which the fluid passage from the line 40 to the spray nozzle 22 is opened, but the fluid passage from the line 39 to the spray nozzle 22 is shut off. When the defined position of the piston 2 has been detected, at least the first fluid valve 21 or the third fluid valve 35 for the passage from the first fluid chamber 3 to the spray nozzle 22 is shut off.

This changeover of the three fluid valves 21, 36, 35 has the effect that then, conversely, the fluid 26 flows under pressure via the line 25 through the first fluid valve 21 into the first fluid chamber 3. The fluid here exerts force upon the piston 2, so that the latter is moved in the direction of a reduction in the volume of the second fluid chamber 34, to the right in the illustration according to FIG. 2. The first fluid chamber 3 is then filled. As a result of this filling, however, the fluid located in the second fluid chamber 34 is pressed via the line 16, through the second fluid valve 36, via the line 40, through the third fluid valve 35, to the spray nozzle 22 where it is expelled in a fluid jet 23.

This expulsion operation lasts until the magnetic field generated by the permanent magnet 30 at the location of the second sensor 39 reaches a field strength which causes a change of state of the second sensor 39. As soon as such a change of state has been detected by the control device 28, the fluid valves 21, 36 and 35 are switched back again, as explained above, so that the second fluid chamber 34 is then filled and the fluid located in the first fluid chamber 3 is thereby expelled as a fluid jet 23.

These expulsion operations may, for example, take place as long as the user has actuated the trigger 31. When the user releases the trigger 31, the expulsion operation carried out at that particular moment is terminated, whereupon the third fluid valve 35 is brought into the completely shutting-off middle setting. Alternatively, a single expulsion operation could be carried out when the trigger 31 is pressed. The next expulsion operation is then triggered only after the repeated actuation of the trigger 31.

The fluid is expelled by the spray gun of the second exemplary embodiment, as in the spray gun of the first exemplary embodiment, as a fluid jet 23 which has a constant expulsion velocity up to the end of the expulsion operation, so that the fluid jet 23 reaches its target completely. Moreover, switching the fluid valves 21, 36 and 35 prevents fluid from dripping.

The third exemplary embodiment of the spray gun according to the invention is explained hereinafter with reference to FIG. 3:

In the third exemplary embodiment, parts which have the same function as in the first and/or the second exemplary embodiment are designated by the same reference symbols. The function of these parts is also the same as in the first and/or the second exemplary embodiment, and therefore the description of these parts is not repeated in detail.

The basic functioning of the spray gun of the third exemplary embodiment corresponds to the spray gun of the second exemplary embodiment. In this case, however, a single cylinder 1 comprising two fluid chambers 3 and 34 which are separated by the piston 2 is not provided, but, instead, two cylinders 1-1 and 1-2 are provided. However, the functional principle corresponds essentially to the functional principle of the spray gun of the second exemplary embodiment.

A first fluid chamber 3-1 with a first cylinder orifice 5-1 is formed in the first cylinder 1-1. Further, a first pressure chamber 4-1 is formed in the first cylinder 1-1. A movable first piston 2-1 is arranged between the first fluid chamber 3-1 and the first pressure chamber 4-1.

Correspondingly, a second fluid chamber 3-2 with a second cylinder orifice 5-2 is formed in the second cylinder 1-2. A second pressure chamber 4-2 is formed in the second cylinder 1-2, too, a movable second piston 2-2 being arranged between the second fluid chamber 3-2 and the second pressure chamber 4-2. The first pressure chamber 4-1 and the second pressure chamber 4-2 communicate with one another via a line 42. A non-compressible working fluid, such as, for example, oil, is located in the first and the second pressure chamber 4-1, 4-2 and the line 42. Furthermore, the line 42 may be connected to a reservoir 43 for the working fluid. The volume of the working fluid in the two pressure chambers 4-1, 4-2 and the line 42 can be varied via the reservoir 43. The maximum volume of the two fluid chambers 3-1, 3-2 and, consequently, the expelled fluid volume can be set in this way.

Alternatively or additionally, as in the spray gun of the second exemplary embodiment, the two sensors 29-1, 29-2 may be adjustable in the longitudinal direction of the cylinder 1-1, 1-2, so that the fluid volume to be discharged can be adapted by the position of the sensors 29-1, 29-2 being varied.

The working fluid transmits force exerted by the first piston 2-1 to the second piston 2-2, and vice versa. The unit formed from the first piston 2-1, the working fluid and the second piston 2-2 thus corresponds to the piston 2 of the spray gun of the second exemplary embodiment.

The spray gun of the third exemplary embodiment comprises two fluid valves 44 and 45. The fluid valve 44 is also designated hereinafter as a first fluid valve 44. Since the fluid valve 45 corresponds functionally to the third fluid valve 35 of the second exemplary embodiment, this fluid valve 45 is also designed hereinafter as a third fluid valve 45.

The first cylinder orifice 5-1 of the first fluid chamber 3-1 is connected via a line 46 to a connection of the first fluid valve 44 and of the third fluid valve 45. Furthermore, the second cylinder orifice 5-2 of the second fluid chamber 3-2 is connected via a line 47 to another connection of the first fluid valve 44 and to another connection of the third fluid valve 45. A further connection of the first fluid valve 44 is coupled via a line 25 to the fluid reservoir 24 in which the fluid 26 is located. As in the first two exemplary embodiments, the fluid reservoir 24 is coupled via a compressed air line 8 and an optional shut-off valve 19 to a device 18 for the provision of compressed air. It would, however, also be possible, as described with regard to the spray gun of the second exemplary embodiment, to put the fluid under pressure directly, for example by means of a pump. The first fluid valve 44 is activated by the control device 28. In one state of the first fluid valve 44, a passage from the line 25 to the line 46 is provided, the passage from the line 25 to the line 47 being shut off. In the other state, a passage from the line 25 to the line 47 is provided, the passage from the line 25 to the line 46 being shut off.

The third fluid valve 45 is also activated by the control device 28, in one state a passage from the line 46 to the spray nozzle 22 being opened, whereas the passage from the line 47 to the spray nozzle 22 is shut off. In another state, the passage from the line 46 to the spray nozzle 22 is shut off, whereas the passage from the line 47 to the spray nozzle 22 is opened. Furthermore, as in the spray gun of the second exemplary embodiment, a middle setting is provided, in which both passages to the spray nozzle 22 are shut off.

Similarly to the spray guns of the first two exemplary embodiments, a first sensor 29-1 is provided for the first cylinder 1-1 in the first fluid chamber 3-1 and detects the position of the first piston 2-1 owing to a magnetic field generated by a first permanent magnet 30-1. Likewise, a second sensor 29-2 is provided in the second fluid chamber 3-2 of the second piston 1-2 and detects the position of the second piston 2-2, in that, as explained with regard to the second exemplary embodiment, a change of state of the second sensor 29-2 is detected by means of the field strength of a magnetic field generated by a second permanent magnet 30-2 which is arranged at the second piston 2-2. As in the spray gun of the second exemplary embodiment, the signals of the two sensors 29-1 and 29-2 are transmitted to the control device 28, which activates the two fluid valves 44 and 45 as a function of these signals.

As in the spray gun of the second exemplary embodiment, the fluid volume to be discharged can be set by means of the positioning of the two sensors 29-1, 29-2 in the longitudinal direction of the cylinders 1-1, 1-2.

A spraying operation which is carried out by the spray gun of the third exemplary embodiment is explained hereinafter:

As in the two preceding exemplary embodiments, fluid expulsion is initiated in that a user actuates the trigger 31, which is connected to the control device 28, continuously or once per expulsion operation.

First, the control device 28 activates the first fluid valve 44 such that a fluid passage from the line 25 to the line 46 is provided, so that the first fluid chamber 3-1 can be filled with fluid 26. The third fluid valve 45 is first in the middle setting in which the two passages are shut off. The first fluid chamber 3-1 is filled with fluid, with the result that the piston 2-1 is moved to the right in the illustration according to FIG. 3, so that the volume of the first fluid chamber 3-1 increases. At the same time, as a result of the transmission of force by the working fluid, the second piston 2-2 moves to the left in the illustration according to FIG. 3, in the direction of a reduction in the volume of the second fluid chamber 3-2. If air is still located in the second fluid chamber 3-2 when the spray gun is put into operation, an outlet valve (not shown) may be provided for this air. The first piston 2-1 is moved in the direction of an increase in the volume of the first fluid chamber 3-1 until the first piston 2-1 butts against a stop which may be provided by a cylinder wall or, as in the spray gun of the first exemplary embodiment, by a setscrew. The control device 28 then changes over the first fluid valve 44 such that a fluid passage from the line 25 into the line 47 is provided. Furthermore, the third fluid valve 45 is switched such that a fluid passage from the line 46 to the spray nozzle 22 is opened.

By the action of pressure upon the fluid reservoir 24, then, the fluid 26 is pressed through the first fluid valve 44 and the line 47 into the second fluid chamber 3-2. Alternatively, as in the spray gun of the second exemplary embodiment, the fluid may also be put under pressure, for example, by means of a pump. The second piston 2-2 is thereby moved in the direction of an increase in the volume of the second fluid chamber 3-2. At the same time, as a result of communication between the two pressure chambers 4-1 and 4-2, the first piston 2-1 is moved in the direction of a reduction in the volume of the first fluid chamber 3-1, with the result that fluid is pressed out of the first fluid chamber 3-1 via the line 46 through the third fluid valve 45 to the spray nozzle 22, where it is expelled as a fluid jet 23.

When the first piston 2-1 has reached the defined position, this being detected by the first sensor 29-1, as explained above, the control device 28 switches the third fluid valve 45 in such a way that the fluid passage from the line 46 to the spray nozzle 22 is shut off. The third fluid valve 45 is in this case brought, in particular, into the completely shutting-off middle setting. The first fluid valve 44 is thereupon changed over, so that a fluid passage from the line 25 to the line 46 is opened. The third fluid valve 45 is then brought into a setting in which a passage from the line 47 to the spray nozzle 22 is provided. By the action of pressure upon the fluid reservoir 24, then, fluid 26 is pressed through the first fluid valve 44 and the line 46 into the first fluid chamber 3-1. The first piston 2-1 is thereby moved in the direction of an increase in the volume of the first fluid chamber 3-1. At the same time, the second piston 2-2 is moved in the direction of a reduction in the volume of the second fluid chamber 3-2, with the result that the fluid located in the second fluid chamber 3-2 is pressed through the line 47 and through the third fluid valve 45 to the spray nozzle 22, where it is expelled as a fluid jet 23. When the second piston 2-2 has reached the defined position within the second cylinder 1-2, as explained above, this is detected by the second sensor 29-2. The control device 28 thereupon activates the two fluid valves 44 and 45 again such that the operation of expelling the fluid from the second fluid chamber 3-2 is interrupted, the second fluid chamber 3-2 is refilled and a further operation to expel the fluid located in the first fluid chamber 3-1 thereby commences.

The spray guns described above are used, in particular, for the expulsion of liquids. The liquids comprise, in particular, at least one active substance for plant protection.

### LIST OF REFERENCE SYMBOLS

1 Cylinder
1-1 First cylinder
1-2 Second cylinder
2 Piston
3 Fluid chamber; first fluid chamber
3-1 First fluid chamber
3-2 Second fluid chamber
4 Pressure chamber
4-1 First pressure chamber
4-2 Second pressure chamber
5 First cylinder orifice
5-1 First cylinder orifice
5-2 First cylinder orifice
6 Second cylinder orifice
7 First connection
8 Compressed air line
9 Shank of the piston 2
10 Bearing
11 Cylinder
12 Plate
13 Compression spring
14 Screw
15 Closing-off wall
16 Line
17 Compressed gas valve
18 Device for the provision of compressed air
19 Shut-off valve
20 Line
21 Fluid valve; first fluid valve
22 Spray nozzle
23 Fluid jet
24 Fluid reservoir
25 Line
26 Fluid
27 Line
28 Control device
29 Sensor; first sensor
30 Permanent magnet
31 Trigger
32 Second connection
33 Third connection
34 Second fluid chamber
35 Third fluid valve
36 Second fluid valve
37 Connection
38 Line
39 Line
40 Line
41 Connection
42 Line
43 Reservoir
44 Fluid valve; first fluid valve
45 Fluid valve; third fluid valve
46 Line
47 Line

1-15. (canceled)

16. A spray gun for the expulsion of a fluid, with
at least one cylinder (1) in which a piston (2) is mounted movably, the cylinder (1) having formed in it a fluid chamber (3), the volume of which can be varied by means of a movement of the piston (2) and in which at least one first cylinder orifice (5) is formed, and
a spray orifice which is connected to the first cylinder orifice (5) of the cylinder (1) via a connecting line (20), so that a fluid, which is received by the fluid chamber (3) and is pressed out through the first cylinder orifice (5) by means of the pressure exerted by the piston (2), arrives via the connecting line (20) at the spray orifice and is expelled there,
wherein
a fluid valve (21) is arranged in the connecting line (20), and
in the cylinder (1) a sensor (29) is provided, by means of which a defined position of the piston (2), in which fluid is still located in the fluid chamber (3) during the expulsion operation, can be detected, and by means of which the fluid valve (21) can be actuated, the fluid valve (21) being closed by means of the sensor (29) when the defined position of the piston (2) has been detected.

17. The spray gun according to claim 16,
wherein
the defined position of the piston (2) is detected by the sensor (29) by means of a magnetic field generated or varied by the piston (2).

18. The spray gun according to claim 16,
wherein,
the cylinder (3) forms in it a pressure chamber (4), in which is formed at least one second cylinder orifice (6) which is connected to a first connection (7) for a compressed gas line (8).

19. The spray gun according to claim 16,
wherein
the spray gun has a second connection (32) for a fluid reservoir (24), which connection is connected to the first cylinder orifice (5) and via which fluid can be conveyed into the fluid chamber (3).

20. The spray gun according to claim 16,
wherein
the fluid valve (21) is a first 3/2-way valve, in which, in a first setting, a passage of fluid from the first cylinder orifice (5) to the spray orifice is provided, and, in a second setting, a passage of fluid from the second connection (32) to the first cylinder orifice (5) is provided.

21. The spray gun according to claim 18,
wherein
between the first connection (7) and the second cylinder orifice (6), a compressed gas valve (17) designed as a second 3/2-way valve is arranged, in which, in a first setting, a passage of compressed gas from the first connection (7) to the second cylinder orifice (6) is provided, and, in a second setting, a passage of compressed gas from the second cylinder orifice (6) into the open is provided.

22. The spray gun according to claim 21,
wherein
the sensor (29) is coupled to the first and the second 3/2-way valve, and the sensor (29) switches the first and the second 3/2-way valve into the second setting when the piston (2) is in the defined position, so that the expulsion of fluid through the spray orifice is interrupted and fluid is conveyed by means of the compressed gas from the fluid reservoir (24) into the fluid chamber (3) via the first 3/2-way valve (21).

23. The spray gun according to claim 21,
wherein
the spray gun has a trigger (31) which is coupled to the first and the second 3/2-way valve and which, when actuated, switches the first and the second 3/2-way valve into the first setting, so that the piston (2) is moved by the compressed gas in the pressure chamber (4), such that the volume of the fluid chamber (3) is reduced and fluid is expelled through the spray orifice.

24. The spray gun according to claim 16,
wherein
the spray gun has a regulating device (14, 15), by means of which the movement of the piston (2) in the cylinder (1) and, consequently, the maximum volume of the fluid chamber (3) can be limited.

25. The spray gun according to claim 16
wherein
a first and a second fluid chamber (3, 34) are formed in the cylinder (1), and at least the first cylinder orifice (5) is formed in the first fluid chamber (3) and at least one second cylinder orifice (6) is formed in the second fluid chamber (34),
the fluid received by the first fluid chamber (3) can be pressed out by fluid being pressed under pressure into the second fluid chamber (34), with the result that force is exerted upon the piston (2) in the direction of a reduction in the size of the first fluid chamber (3), and
the fluid received by the second fluid chamber (34) can be pressed out by fluid being pressed under pressure into the first fluid chamber (3), with the result that force is exerted upon the piston (2) in the direction of a reduction in the size of the second fluid chamber (34).

26. The spray gun according to claim 16,
wherein
the spray gun comprises a first and a second cylinder (1-1, 1-2),
in that a first fluid chamber (3-1) with a first cylinder orifice (5-1) is formed in the first cylinder (1-1) and a second fluid chamber (3-2) with a second cylinder orifice (5-2) is formed in the second cylinder (1-2),
in that a first pressure chamber (4-1) is formed in the first cylinder (1-1) and a second pressure chamber (4-2) is formed in the second cylinder (1-2), the first and the second pressure chamber (4-1, 4-2) communicating with one another and comprising a non-compressible working fluid,
the first fluid chamber (3-1) is separated from the first pressure chamber (4-1) by a first piston (2-1), and the second fluid chamber (3-2) is separated from the second pressure chamber (4-2) by a second piston (2-2), the volume of the first fluid chamber (4-1) decreasing when the volume of the second fluid chamber (4-2) increases,
the fluid received by the first fluid chamber (3-1) can be pressed out by fluid being pressed under pressure into the second fluid chamber (3-2), with the result that force is exerted upon the second piston (2-2) and is transmitted to the first piston (2-1) via the working fluid, and
the fluid received by the second fluid chamber (3-2) can be pressed out by fluid being pressed under pressure into the first fluid chamber (3-1), with the result that force is exerted upon the first piston (2-1) and is transmitted to the second piston (2-2) via the working fluid.

27. The spray gun according to claim 16,
wherein
the fluid is a liquid, and the spray orifice is surrounded by a spray nozzle (22) which, when the liquid passes through it, generates a liquid jet (23).
